(19) United States
(12) Patent Application Publication
(10) Pub. No.: US 2004/0073706 A1
(43) Pub. Date: Apr. 15, 2004

(54) Electronic mail system and program for the electronic mail system

(75) Inventors: Masashi Eguchi, Joyo-shi (JP); Yoshifumi Tanimoto, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Murata Kikai Kabushiki Kaisha, Kyoto-shi (JP)

(21) Appl. No.: 10/670,385

(22) Filed: Sep. 26, 2003

(30) Foreign Application Priority Data
Oct. 7, 2002 (JP) 2002-293264

(51) Int. Cl. G06F 15/16

(52) U.S. Cl. 709/245

(57) ABSTRACT

An Internet facsimile server, a mail server, an LDAP server, and a DHCP server are connected to a LAN. When the Internet facsimile server obtains an IP address from the DHCP server, the Internet facsimile server transmits its own electronic mail address and IP address to the LDAP server, and the LDAP server records the electronic mail address and the IP address to a correspondence chart. The mail server that received an electronic mail obtains an IP address from the electronic mail address by referring to the correspondence chart, and transmits the electronic mail to the Internet facsimile server by SMTP. An electronic mail can be distributed to the Internet facsimile server without using a DNS server.

### FIELD OF THE INVENTION

The present invention relates to an electronic mail system and a program for the electronic mail system, and more particularly to a system and a program which can forward an electronic mail without using a Domain Name System (DNS) server.

### DESCRIPTION OF THE RELATED ART

Conventionally, when transmitting an electronic mail by a Simple Mail Transfer Protocol (SMTP), a relay mail server requests a network address of a destination from a Domain Name System (DNS) server. By using the DNS server, an electronic mail can be forwarded even if the network address is unknown.

However, under such an electronic mail distribution protocol by the SMTP, the DNS server is absolutely imperative, and costs and attention are required for providing, maintaining, and managing the DNS server. Meanwhile, in a client-centered network such as a Local Area Network (LAN), many of the clients use a mail server as a Post Office Protocol (POP) server, and retrieve an electronic mail addressed to oneself from a mailbox provided in the mail server or the like. Therefore, it becomes less necessary to provide a DNS server for obtaining an internal network address of a LAN or the like for the reception of an electronic mail by the POP.

### SUMMARY OF THE INVENTION

An advantage of the present invention is to not require a DNS server for forwarding an electronic mail. Another advantage of the present invention is to forward an electronic mail without using a DNS server or the like even when a Dynamic Host Configuration Protocol (DHCP) server is provided and a network address is assigned to a terminal dynamically. Furthermore, another advantage of the present invention is to facilitate SMTP forwarding of an electronic mail to a communication server such as an Internet facsimile server.

An electronic mail system of the present invention includes a mail server, and an address conversion unit for managing address conversion data to convert an electronic mail address of a destination terminal into a network address. The address conversion unit is provided in a mail server or a directory server. In addition, the address conversion unit obtains a network address by using an electronic mail address included in the received electronic mail, and the electronic mail is transmitted from the mail server to the obtained network address.

The network address is an Internet Protocol (IP) address or the like, but the network address is not limited to this example. The electronic mail address is a terminal name or the like in a nimonic described by alphanumeric characters. Moreover, the address conversion data in the address conversion unit is stored under a table format or the like, but can also be stored by using a structured document such as an extensible Markup Language (XML).

According to another aspect of the present invention, when a destination terminal is assigned with a network address, a terminal name of the destination terminal and the network address are sent from the destination terminal to a server that has an address conversion unit. Then, the network address included in the address conversion data is updated.

The notification can be carried out indirectly from the destination terminal via a mail server or the like. The destination terminal is preferable to be a communication server which can carry out an image communication by the Internet.

A program for the electronic mail system of the present invention includes a command for storing and managing address conversion data to convert an electronic mail address of a destination terminal into a network address. The program also includes a command for obtaining a network address by referring to the address conversion data by the electronic mail address when receiving an electronic mail of an electronic mail address other than that of the mailbox managed by the mail server.

The network address is an IP address or the like, but the network address is not limited to this example. The electronic mail address is a terminal name or the like in a nimonic described by alphanumeric characters. Moreover, the address conversion data in the address conversion unit is stored under a table format or the like, but can be stored by using a structured document such as an XML.

According to another aspect of the present invention, the program also includes a command for a destination terminal to notify a server that manages the address conversion data with a terminal name of the destination terminal and a network address when the destination terminal is assigned with a network address by a server that assigns network addresses.

The notification can be carried out indirectly from the destination terminal via a mail server or the like.

According to the present invention, the address conversion data is stored for converting an electronic mail address of a destination terminal into a network address. The mail server converts the electronic mail address included in the electronic mail into a network address by the address conversion data. Then, the mail server forwards the received electronic mail by a Simple Mail Transfer Protocol (SMTP) or the like to the obtained network address. As a result, the mail server can forward the electronic mail to the destination terminal without using the DNS server. Further, the mail server can distribute the electronic mail to a mailbox for the destination terminal which has a mailbox. As a result, the electronic mail can be forwarded to a destination terminal within the LAN or the like without using the DNS server.

Further, the address conversion data for converting the electronic mail address into the network address is stored under the management of the mail server, or under the management of a server such as a Light Directory Access Protocol (LDAP) server that presents a directory service. Moreover, in this specification, a server that presents a directory service is referred to as a “directory server”, and the DNS server is not included in the directory server. Furthermore, “providing under the management” means that the address conversion data can be stored, updated, and accessed (searched) from the mail server or the directory server, and the data can be located in another server such as a document management server.

Here, when assigning a network address to a destination terminal dynamically by using the DHCP server, the terminal name of the destination terminal and the network address are sent to the server that manages the address conversion data from the destination terminal assigned with the network address. Then, according to a change in the network address, it is preferable to update the address conversion data automatically. Moreover, in case a new destination terminal is added to the LAN or the like, when a network address is assigned, it is preferable for the new destination terminal to notify a server that manages the address conversion data with the terminal name and the network address, and to update the address conversion data automatically. Therefore, the case in which the network address is assigned dynamically can be dealt with accordingly.

Furthermore, when the destination terminal is a communication server which can carry out an Internet facsimile or the like, the electronic mail can be forwarded easily by the SMTP or the like from the mail server to the communication server. Therefore, the communication server can forward the electronic mail by the SMTP or the like without using the DNS server and without storing the electronic mail in the mailbox of the mail server. Further, other mail clients can receive the electronic mail by using a mailbox by the POP or the like.

### BRIEF DESCRIPTION OF THE DRAWINGS

FIG. 1 is a block diagram showing a configuration of an electronic mail system according to a preferred embodiment of the present invention.

FIG. 2 is a schematic diagram showing a correspondence chart of an electronic mail address and an IP address to be used in the preferred embodiment.

FIG. 3 shows a relationship of connections established at a reception of an electronic mail in the electronic mail system of the preferred embodiment.

FIG. 4 shows processes to be used in the electronic mail system of the preferred embodiment.

FIG. 5 is a flowchart showing a process in which an Internet facsimile server obtains an IP address and registers the IP address with the correspondence chart of an LDAP server in the electronic mail system of the preferred embodiment.

FIG. 6 is a flowchart showing a process in which a mail server receives an electronic mail, inquires with the LDAP server to obtain the IP address of the Internet facsimile server, and transmits the electronic mail.

### DETAILED DESCRIPTION OF THE PREFERRED EMBODIMENTS

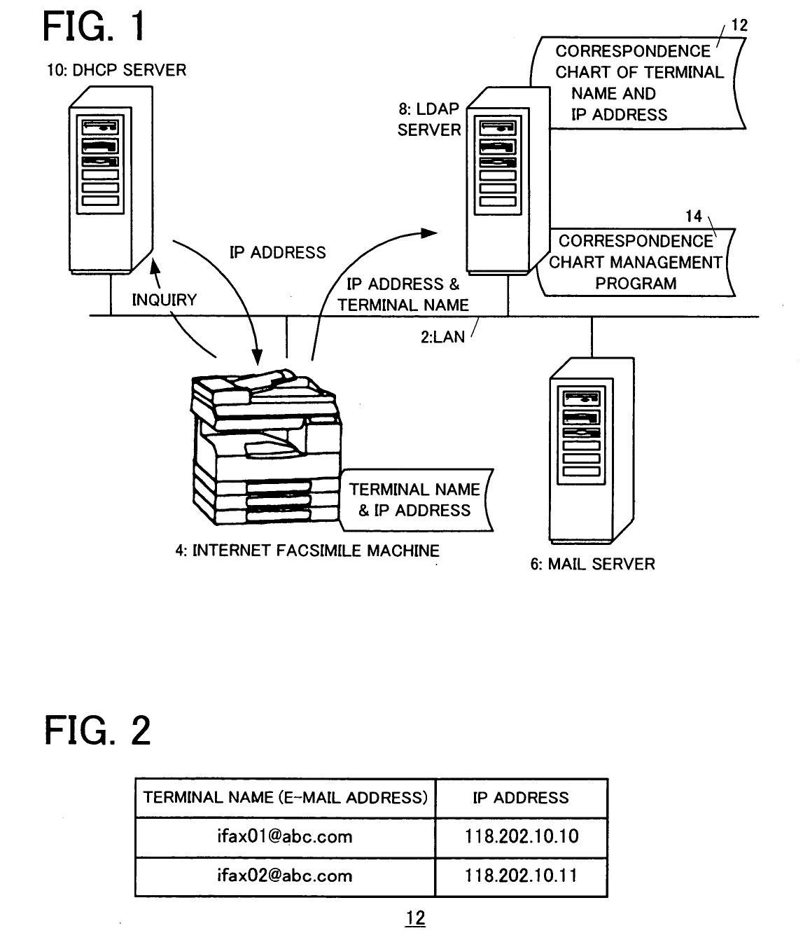

FIGS. 1-6 show an electronic mail system and a program of the electronic mail system according to a preferred embodiment of the present invention. In FIG. 1, reference number 2 denotes a Local Area Network (LAN), and reference number 4 an Internet facsimile machine, which is a communication machine that can transmit and receive image data such as facsimile data via the Internet under an electronic mail format. The Internet facsimile machine 4 stores a terminal name (electronic mail address) of the Internet facsimile machine 4 itself and an Internet Protocol (IP) address (network address) as a destination of electronic mail, and receives electronic mail by a Simple Mail Transfer Protocol (SMPT) Reference number 6 denotes a mail server, and the Internet facsimile machine 4 is a client of the mail server 6. The mail server 6 also has other clients such as a personal computer. The mail server 6 includes mailboxes for clients such as a personal computer, and temporarily stores received electronic mail in a mailbox.

Reference number 8 denotes a Lightweight Directory Access Protocol (LDAP) server, and 10, a Dynamic Host Configuration Protocol (DHCP) server. The LAN 2 is a local network which mainly includes terminal apparatus of clients or the like. A DNS server is not necessary for the LAN 2, and even when providing a DNS server, the DNS server can be small scaled which covers only major servers such as the mail server 6 or a World Wide Web (WEB) server (not shown in the drawings).

Reference number 12 denotes a correspondence chart (table) of a terminal name (electronic mail addresses) and an IP address (network addresses). Here, the correspondence chart 12 is provided in the LDAP server 8, and the LDAP server 8 forms, stores, and updates the correspondence chart 12. In place of the correspondence chart 12, an extensible Markup Language (XML) document or the like can be formed such that a network address can be searched by a terminal name. Moreover, the mail server 6 can access the correspondence chart 12 via the LDAP server 8, search the correspondence chart 12 by the electronic mail address, and obtain the IP address. The contents of the correspondence chart 12 are shown schematically in FIG. 2. The terminal name (electronic mail address) is stored in the left column of the correspondence chart 12, and the IP address (network address) is stored in the right column.

Further, it is not necessary to describe in the correspondence chart 12, the client of the mail server which receives the electronic mail by POP. Although the Internet facsimile machine 4 is a client of the mail server 6, since the reception is carried out by the SMTP, it is necessary to describe the Internet facsimile machine 4 in the correspondence chart 12. In FIG. 1, reference number 14 denotes a correspondence chart management program, and is an example of a program of the present invention.

Further, the IP address mentioned here is not limited to the IP address in the exact meaning following the Internet protocol, and can be a network address that is valid only in the LAN 2. In addition, the correspondence chart 12 can store the date and time when an IP address was updated in the correspondence chart 12. When a prescribed period of time or a prescribed number of days elapses, in consideration of the possibility of the IP address being changed by the DHCP server 10, a retransmission of the terminal name and the IP address can be requested to the Internet facsimile machine 4 or the like by a broadcast or the like from the LDAP server 8 that manages the correspondence chart 12.

In the present embodiment, the correspondence chart 12 is provided in the LDAP server 8, but the correspondence chart 12 can be provided in the mail server 6. Moreover, the correspondence chart 12 can be stored in a remote server other than the mail server 6 and the LDAP server 8, without storing the correspondence chart 12 directly in the mail server 6 or the LDAP server 8. However, in this case, the correspondence chart 12 can be formed, updated, and accessed from the mail server 6 or the LDAP server 8, such that the correspondence chart 12 can be managed by the mail server 6 or the LDAP server 8. When the Internet facsimile machine 4 inquires the DHCP server 10 as to the IP address of the Internet facsimile machine 4 itself and is assigned with an IP address, the Internet facsimile machine 4 notifies the LDAP server 8 with the terminal name (electronic mail address) and the IP address of the Internet facsimile machine 4 itself. Then, the LDAP server 8 updates the correspondence chart 12 to maintain the IP address in the newest state.

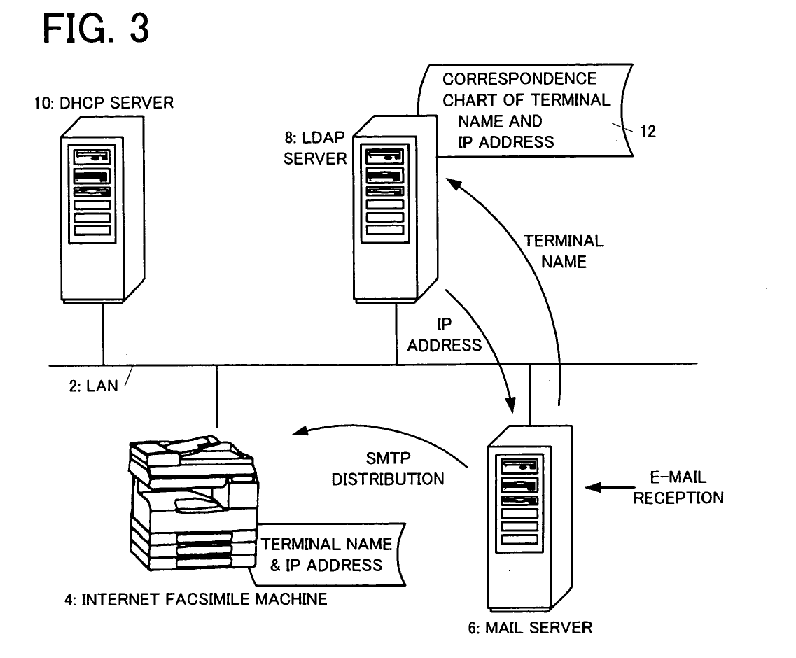

FIG. 3 shows a process for forwarding an electronic mail. For example, when the mail server 6 receives an electronic mail addressed to the Internet facsimile machine 4, the mail server 6 inquires to the LDAP server 8 by using the destination terminal name (electronic mail address) included in the received electronic mail. The LDAP server 8 searches the correspondence chart 12, and transmits the electronic mail address of the Internet facsimile machine 4 and the IP address to the mail server 6. Then, the mail server 6 carries out SMTP distribution of the received electronic mail to the IP address notified from the LDAP server 8. As a result, the mail server 6 can distribute the electronic mail to the Internet facsimile machine 4 without using the DNS server and without accumulating the electronic mail in the mailbox. From a point of view of the Internet facsimile machine 4, the electronic mail can be received immediately without being accumulated in the mailbox. Further, a client, which has a mailbox in the mail server 6, and does not need an SMTP distribution, can retrieve electronic mail from the mailbox by a protocol such as a POP3.

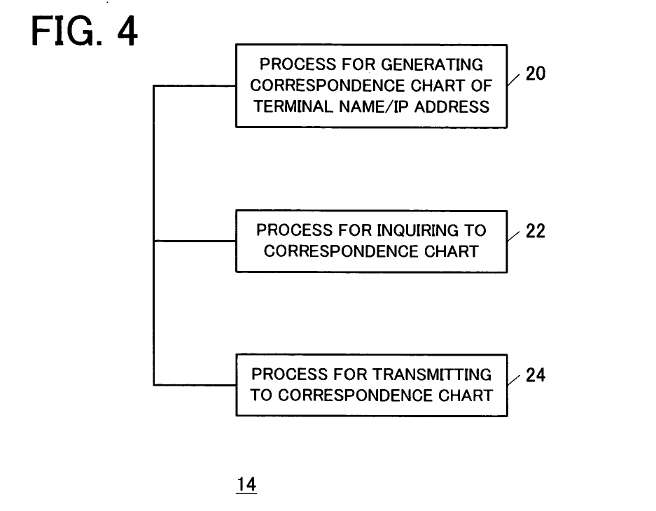

As shown in FIG. 4, the correspondence chart management program 14 is formed from the following three processes. That is, (1) a process 20 for generating a correspondence chart which forms and updates a correspondence chart of the terminal name (electronic mail address) and the IP address (network address), and executes searching according to an access made from the mail server 6 or the like; (2) a process for inquiring 22 which requests the LDAP server 8 to search the correspondence chart, and inquires to obtain an IP address from the terminal name electronic mail address); and (3) a process for transmitting 24 which transmits the terminal name (electronic mail address) of the Internet facsimile machine 4 itself or the like and the IP address (network address) from the Internet facsimile machine 4 or the like to the LDAP server 8 that manages the correspondence chart.

The process 20 for generating the correspondence chart is implemented in the LDAP server 8, the process for inquiring 22 is implemented in the mail server 6 or the like, and the process for transmitting 24 is implemented in the Internet facsimile machine 4 or the like. When storing the correspondence chart 12 under the management of the mail server 6, the process for generating the correspondence chart 20 and the process for inquiring 22 can be stored in the mail server 6 as one whole process. Furthermore, the correspondence chart management program 14 can be loaded and obtained from the Internet or an appropriate storage medium by the Internet facsimile machine 4, the mail server 6, the LDAP server 8 or the like. In this case, the processes 20 and 22 that are necessary for the mail server 6 and the LDAP server 8 can be transmitted from the Internet facsimile machine 4 or the like to the mail server 6 and the LDAP server 8, and stored in the mail server 6 and the LDAP server 8.

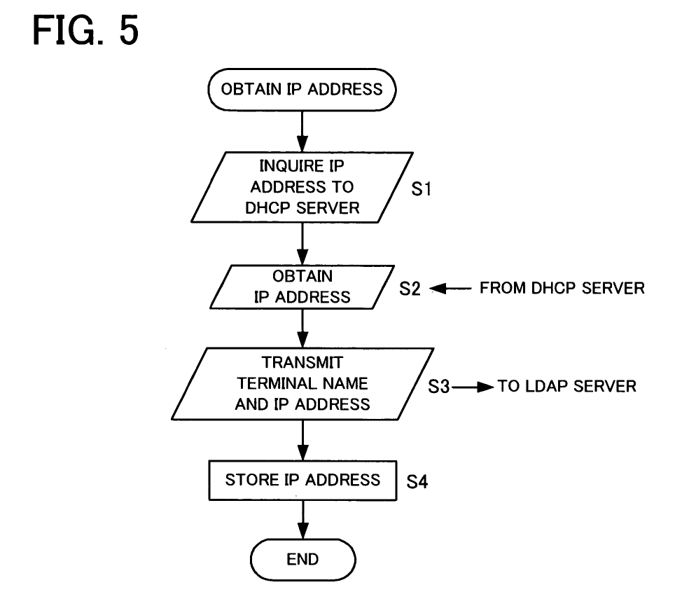

FIG. 5 shows a flowchart of the Internet facsimile machine 4 obtaining an IP address. In step S1, the Internet facsimile machine 4 inquires the DHCP server as to the IP address of the Internet facsimile machine 4 itself. When obtaining an IP address (step S2), the Internet facsimile machine 4 transmits the terminal name and the IP address to the LDAP server (step S3), and the terminal name and the IP address are stored in the correspondence chart 12 (step S4). The flowchart of FIG. 5 is repeated each time the Internet facsimile machine 4 obtains an IP address. Therefore, the newest IP address is stored in the correspondence chart 12 at all times.

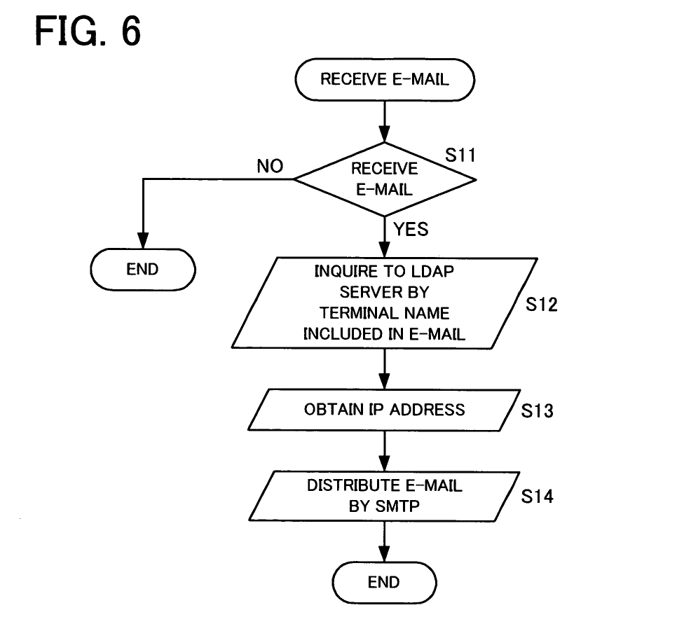

FIG. 6 shows a flowchart for the mail server 6 receiving an electronic mail. When receiving an electronic mail in step S11, the mail server 6 inquires to the LDAP server 8 by using the terminal name (electronic mail address) included in the electronic mail (step S12). The LDAP server 8 searches the correspondence table 12, and transmits the IP address to the mail server 6 (step S13). Then, the mail server 6 distributes the electronic mail by the SMTP by using the obtained IP address (step S14). The electronic mail addressed to a terminal which the mailbox is provided in the mail server 6 is stored in the mailbox without being inquired to the LDAP server 8. Moreover, when the inquiry to the LDAP server 8 fails, the electronic mail can be stored in the mailbox. Further, in the present embodiment, the client which receives the SMTP distribution of the electronic mail is the Internet facsimile machine 4, but the client can be other servers or clients on the LAN 2.

What is claimed is:

1. An electronic mail system comprising:
a mail server which transmits and receives an electronic mail; and
means for converting an electronic mail address of a destination terminal into a network address;
wherein the mail server obtains the network address by the means for converting by using the electronic mail address included in the received electronic mail, and transmits the electronic mail to the obtained network address.

2. The electronic mail system according to claim 1, wherein when the destination terminal is assigned with a network address, the destination terminal notifies the means for converting with the terminal name of the destination terminal and the network address, and updates the network address included in the address conversion data.

3. The electronic mail system according to claim 2, wherein the destination terminal is an Internet facsimile machine which can carry out an image communication by the Internet.

4. An electronic mail system comprising:
an address conversion unit which stores address conversion data for converting an electronic mail address of a destination terminal into a network address;
an electronic mail reception unit which receives electronic mail;
an inquiry unit which obtains the network address from the address conversion unit by using an electronic mail address of a destination terminal included in the received electronic mail; and
an electronic mail transmission unit which transmits the electronic mail to the obtained network address.

5. The electronic mail system according to claim 4, comprising:
a directory server which includes the address conversion unit; and
an electronic mail server which includes the electronic mail reception unit, the inquiry unit, and the electronic mail transmission unit.

6. The electronic mail system according to claim 4, wherein the mail server includes the address conversion unit, the electronic mail reception unit, the inquiry unit, and the electronic mail transmission unit.

7. The electronic mail system according to claim 4, comprising:
an updating unit which updates the network address included in the address conversion data by notifying the address conversion unit from the destination terminal with the terminal name of the destination terminal and the network address when the destination terminal is assigned with a network address.

8. The electronic mail system according to claim 4, wherein the address conversion data is a structured document.

9. The electronic mail system according to claim 4, further comprising:
mailboxes for each of the destination terminals;
wherein when there is no mailbox for the destination terminal included in the received electronic mail, the inquiry unit inquires the network address from the address conversion unit.

10. The electronic mail system according to claim 4, further comprising:
mailboxes for each of the destination terminals;
wherein when the inquiry unit fails to obtain the network address from the address conversion unit by using the electronic mail address of the destination terminal included in the received electronic mail, the received electronic mail is stored in the mailbox.

11. The electronic mail system according to claim 4, wherein the address conversion unit stores an update time for the address conversion data, and when a prescribed period of time elapses from the update time, the address conversion unit requests a network address from the destination terminal.

12. A program for an electronic mail system comprising:
a command for storing and managing address conversion data for converting an electronic mail address of a destination terminal into a network address; and
a command for obtaining the network address by referring to the address conversion data by an electronic mail address when receiving an electronic mail of an electronic mail address other than that of the mailbox managed by the mail server.

13. The program for the electronic mail system according to claim 12, further comprising:
a command for the destination terminal to notify a server that manages the address conversion data of a terminal name of the destination terminal and a network address when the destination terminal is assigned with a network address from a server for assigning a network address.
